(19) United States
(12) Patent Application Publication
(10) Pub. No.: US 2005/0079882 A1
(43) Pub. Date: Apr. 14, 2005

(54) Method and system for providing short message service in network interworking between wireless public network and wired/wireless private network

(76) Inventors: Dong-Youl Lee, Suwon-si (KR); Gui-Jung Lee, Yongin-si (KR)

Correspondence Address: ROBERT E. BUSHNELL, 1522 K STREET NW, SUITE 300, WASHINGTON, DC, 20005-1202, US

(21) Appl. No.: 10/961,656

(22) Filed: Oct. 12, 2004

(30) Foreign Application Priority Data
Oct. 13, 2003 (KR) 2003-71225
Feb. 17, 2004 (KR) 2004-10488

(51) Int. Cl. H04Q 7/20

(52) U.S. Cl. 455/466

(57) ABSTRACT

A method and system for providing a short message service (SMS) in a network interworking between a wireless public network and a wired/wireless private network can provide the short message service through the private network directly when a user wishes to transmit the short message service through the private network in the interworking network. The method includes a first step of setting up an identifier determining through which of the public and private networks to transmit the short message service, and a second step of retrieving the transmitted identifier of a terminal and transmitting the short message service to a corresponding network according to retrieved information. Since it is possible to selectively transmit SMS data using the public network or the private network in the interworking network, and the SMS data can be transmitted to the private network by changing the system without changing the terminal of each user, there occurs no additional expense.

### CLAIM OF PRIORITY

This application makes reference to, incorporates the same herein, and claims all benefits accruing under 35 U.S.C. §119 from applications for METHOD OF PROCESSING SHORT MESSAGE SERVICE OF NETWORK INCLUDING WIRELESS PUBLIC NETWORK AND WIRELESS PRIVATE NETWORK AND SYSTEM THEREOF earlier filed in the Korean Intellectual Property Office on 13 Oct. 2003 and there duly assigned Serial No. 2003-71225, and for METHOD OF PROCESSING SHORT MESSAGE SERVICE OF NETWORK INCLUDING WIRELESS PUBLIC NETWORK AND WIRELESS PRIVATE NETWORK AND SYSTEM THEREOF earlier filed in the Korean Intellectual Property Office on 17 Feb. 2004 and there duly assigned Serial No. 2004-10488, respectively.

### BACKGROUND OF THE INVENTION

1. Field of the Invention

The present invention relates to a service provided through a network interworking between wireless public and private networks. More particularly, the present invention relates to a method and system for providing a short message service (SMS) in a network interworking between a wireless public network and a wired/wireless private network, wherein the SMS is provided through the private network directly in the interworking network, when the SMS is intended to be provided through the private network in the interworking network.

2. Description of the Related Art

As a solution for providing voice communication and data services under an in-building office environment free of charge, a system grafting CDMA-RF technology on a local wired/wireless private branch exchange appears for the first time.

Such a system where a wireless public network and a wired/wireless private network interwork with each other makes it possible to make a call anywhere within the building, supports a hand-off function with the wireless public network upon deviation from a local zone, and provides a variety of additional services, for example, of forwarding an emergency message by use of a short message service (SMS), retrieving necessary in-building information at the exterior if an intra-net is established, and so on.

However, this system does not currently support a local SMS function (through the private network).

This is because a terminal cannot discriminate whether the SMS received currently in the private network is provided through the public network or through the private network when the terminal transmits a signal for requesting the SMS.

However, the local SMS (through the private network) is not currently supported by the system. It is because when a terminal transmits the SMS, it cannot be discriminated whether a current SMS is provided through the public network or the private network.

A general form of the SMS will be explained with a transfer route of a short message service (SMS) data through a general wireless public network.

To begin with, when a SMS transmission-side terminal transmits the SMS data, this signal is received at a Base Transceiver Station (BTS) within a corresponding coverage area, matched at a Base Station Controller (BSC), and transmitted to a Mobile Switching Center (MSC).

The MSC transmits the currently received SMS data to the Short Message Service Center (SMSC), and then transmits the data to a SMS reception-side terminal, wherein the SMS reception-side terminal is designated by the SMS transmission-side terminal.

Meanwhile, when this system is coupled with the wired/wireless private network, it should be determined to which of public and private networks a call or signal received in the private network is routed.

However, when the SMS data is transmitted from a local wireless terminal to another local wireless terminal in a conventional network where the wireless public network interworks with the wired/wireless private network, the SMS data is unconditionally provided through the public network because there is no discrimination information indicating through which of the public and private networks the SMS is provided.

Accordingly, there is a problem in that a local SMS (through the private network) is unavailable in the conventional network where the wireless public network interworks with the wired/wireless private network.

### SUMMARY OF THE INVENTION

It is, therefore, an objective of the present invention to provide a method and system for providing a short message service in a network interworking between a wireless public network and a wired/wireless private network, capable of making a user of the private network to selectively use a private network SMS and a public network SMS using a wireless terminal.

It is another objective to provide a method for providing a short message service in a network interworking between a wireless public network and a wired/wireless private network, capable of transmitting the SMS inclusive of receiver information in a specification of each terminal when the SMS is transmitted, thereby making a user transmit SMS data through a network that the user wishes to use when transmitting the SMS.

It is yet another object to provide the SMS data to be transmitted to the private network by upgrading software of the system without changing the hardware and software from the terminal of each user, and therefore accommodating no additional expense being incurred.

It is still another object to provide a method and system for providing a short message service in a network interworking between a wireless public network and a wired/wireless private network, that is easy to implement and is efficient.

In an aspect of the present invention, a method for providing a short message service in a network interworking between a wireless public network and a wired/wireless private network, includes: a first step of setting up an identifier to determine through which of the public and private networks to transmit the short message service; and a second step of retrieving the transmitted identifier of a terminal and transmitting the short message service to a corresponding network according to retrieved information.

In another aspect of the present invention, a method for providing a short message service in a network interworking between a wireless public network and a wired/wireless private network, includes: a first step of, by a user, setting up through which of the public and private networks to transmit the short message service; a second step of storing information set up by the user in a private network database; and a third step of, if an arbitrary user transmits the short message service, retrieving an identifier of the arbitrary user's terminal from the private network database, and providing the short message service through a corresponding one of the public and private networks depending on a status set up in the database.

Preferably, the method further includes a fourth step of releasing a function of setting up the short message service through the private network.

Preferably, the first step is performed by the user inputting and setting up digits using button keys of the wireless terminal.

Preferably, the second step is performed by transmitting short message service data received through the base transceiver station together with the identifier of the corresponding user's terminal to a private network control station, and referring to a field for a private network route set in each entry of a service setup table of the private network short message service in the database of the private network control station.

Preferably, the fourth step is performed by the user inputting and setting up a specified number {a private network access code+a function access code+a characteristic code (a private network short message service releasing function code)} using a button key of the wireless terminal.

Preferably, when a setup of the SMS to be transmitted through the private network after a predetermined time has lapsed is released, a characteristic code that is made by combining a private network short message service setup function code and a code meaning time is inputted and set up.

Preferably, information on the code indicating time inputted and set up by the user using the button keys of the wireless terminal is stored in a timer field of the private network SMS setup table of the private network control station database.

Preferably, in the case of setting up and using the number of times which the SMS passing through the private network is transmitted, a characteristic code that is made by combining the private network short message service set function code and a code indicating the transmission number of times is inputted and set up.

Preferably, the information on the code indicating the transmission number of times that is inputted and set up by the user using the button key of the wireless terminal is stored in the field for the transmission number of times in the private network SMS setup table of the private network control station database.

In yet another aspect of the present invention, a system for providing a short message service in a network interworking between a wireless public network and a wired/wireless private network, includes: at least one of base transceiver stations for receiving data received from an arbitrary wireless terminal or transmitting data to be transmitted to the arbitrary wireless terminal; a public network for taking charge of a data control when transmitting and receiving short message service data through a public network, that is transmitted and received through at least one of the base transceiver station; a private network having a route determination unit for determining through which of the public and private networks to transmit the short message service data using an identifier of an transmission-side terminal included in the short message service data received in the base transceiver station, and transmitting the short message service data to the corresponding network; and a private network dedicated private short message service center for, when the private network determines that currently received short message service data is a private network short message service data, providing the short message service directly in the private network without passing through the public network.

Preferably, the private network includes: a database of a table structure composed of an identifier field of the transmission-side terminal and a field indicating a short message service route; a route determination unit for determining a short message service route for the transmission-side terminal identifier with reference to the database and transmitting the transmission-side terminal identifier of the short message service received through the base transceiver station to the corresponding network between the private network and the public network; and a private network control module for, in the case that data received through a message routing software module is private message service data, transmitting the short message service data to the private short message service center, and when there is an input from the transmission-side terminal with regard to a setup indicating whether to use which of the private and public networks, recording the input detail in the database.

Preferably, the database further includes: a time field for indicating the amount of time that the user wishes to use the network; and a field for indicating the number of times which the user wishes to use the network.

Preferably, the short message service route field of the database is set up as the public network for an initial setup (default) when the user does not arbitrarily set up the short message service route.

Preferably, the private network control module includes: a private network control module for managing a plurality of base transceiver stations and taking charge of a wireless channel setup and frequency hopping process; a private mobile switching center module for taking charge of a signal switching function; and a private visitor location register module for storing location information of a terminal.

In yet another aspect of the present invention, a method for providing a short message service in a network interworking between a wireless public network and a wired/wireless private network, includes: a first step of, by a user, transmitting a short message service (SMS); a second step of determining through which of the public and private networks to transmit the short message service based on terminating number information; a third step of transmitting the short message service to a private short message service center when it is determined that the date is the private network passing short message service data according to the terminating number information; and a fourth step of transmitting the short message service data to the short message service center when it is determined that the data is the public network passing short message service according to the terminating number information.

In yet another aspect of the present invention, a system for providing a short message service in a network interworking between a wireless public network and a wired/wireless private network, includes: a terminal upgraded to transmit a message together with terminating number information when short message service data is transmitted; at least one of base transceiver station for receiving data received from the terminal or transmitting data to be transmitted to an arbitrary wireless terminal; a private network for determining through which of the public and private networks to transmit the short message service data using terminating number information included in the short message service data message received from the terminal; a public network for taking charge of a data control when short message service data that is transmitted and received through at least one of the base transceiver station is transmitted and received through the public network; and a private short message service center for providing the short message service directly in the private network without passing the public network, when it is determined that short message service data currently received from the private network is the private network short message service.

The present invention can also be realized as computer-executable instructions in computer-readable media.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic view showing a transfer route of a short message service (SMS) data through a general wireless public network;

FIG. 2 is a block diagram schematically showing a process of originating an SMS in a conventional network where a wireless public network and a wireless private network interwork with each other;

FIG. 3 is a schematic block diagram showing an SMS transfer route in a network interworking between a wireless public network and a wired/wireless private network in accordance with the present invention;

FIG. 4a is a block diagram schematically showing an SMS transfer route in a system where a private network is connected to a public network MSC stage;

FIG. 4b is a block diagram concretely showing a system where a private network is connected to a public network MSC stage;

FIG. 4c is a block diagram showing an SMS transfer route in a network where a public network interworks with a private network through a hybrid BTS;

FIG. 5 is a block diagram schematically viewing an SMS transfer route in a network where a private network is connected to a BSC stage of a wireless public network in accordance with a first embodiment of the present invention;

FIG. 6 is a block diagram showing a control station of a private network shown in FIG. 5 in detail;

FIG. 7 is a table for a database having data indicating whether an SMS is transferred through a private network;

FIG. 8 is a view showing a basic structure of a transmission message to set up a private network route;

FIG. 9 is a flow chart of a process for setting up a private network SMS by a user in accordance with an embodiment of the present invention;

FIG. 10 is a flow chart showing a process where a user transmits an SMS to a terminal of the other party through a private network in accordance with an embodiment of the present invention;

FIG. 11 is a flow chart showing a process of releasing a private network SMS transmission function in accordance with an embodiment of the present invention;

FIG. 12 is a flow chart showing a process of setting up and releasing a private network SMS transmission function using a timer in accordance with an embodiment of the present invention;

FIG. 13 is a flow chart showing a process of assigning and setting up the number of times of originating transmission with respect to a private network SMS transmission function in accordance with an embodiment of the present invention;

FIG. 14 is a flow chart showing a process of transmitting a private network SMS in the state that the number of times of SMS transmission is determined in accordance with an embodiment of the present invention;

FIG. 15a is a view showing a process of upgrading software of each terminal and transmitting a SMS through a private network in accordance with a second embodiment of the present invention;

FIG. 15b is a view showing a process of upgrading software of each terminal and transmitting a SMS through a public network in accordance with a second embodiment of the present invention; and

FIG. 16 shows an example of a computer including a computer-readable medium having computer-executable instructions for performing a technique of the present invention.

### DETAILED DESCRIPTION OF THE PREFERRED EMBODIMENTS

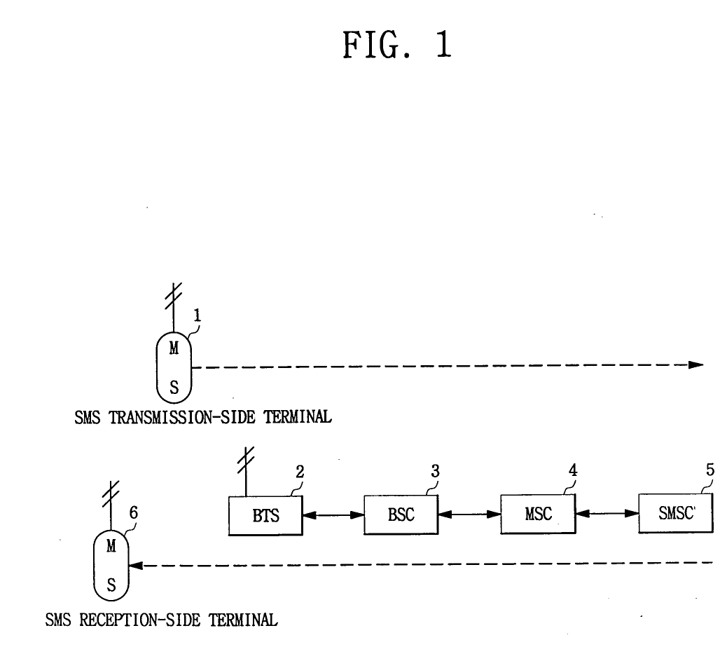

Turning now to the drawings, a general form of the SMS will be explained with reference to FIG. 1.

FIG. 1 schematically shows a transfer route of a short message service (SMS) data through a general wireless public network.

To begin with, when a SMS transmission-side terminal 1 transmits the SMS data, this signal is received at a Base Transceiver Station (BTS) 2 within a corresponding coverage area, matched at a Base Station Controller (BSC) 3, and transmitted to a Mobile Switching Center (MSC) 4.

The MSC 4 transmits the currently received SMS data to the Short Message Service Center (SMSC) 5, and then transmits the data to a SMS reception-side terminal 6, wherein the SMS reception-side terminal 6 is designated by the SMS transmission-side terminal 1.

Meanwhile, when this system is coupled with the wired/wireless private network, it should be determined to which of public and private networks a call or signal received in the private network is routed.

However, when the SMS data is transmitted from a local wireless terminal to another local wireless terminal in a conventional network where the wireless public network interworks with the wired/wireless private network, the SMS data is unconditionally provided through the public network because there is no discrimination information indicating through which of the public and private networks the SMS is provided.

Accordingly, there is a problem in that a local SMS (through the private network) is unavailable in the conventional network where the wireless public network interworks with the wired/wireless private network.

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

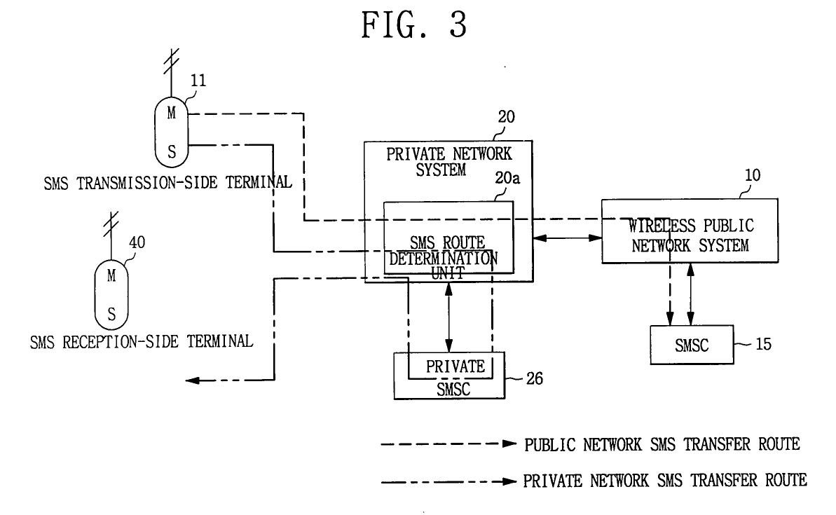

FIG. 3 is a schematic block diagram showing an SMS transfer route in a network interworking between a wireless public network and a wired/wireless private network in accordance with the present invention.

Referring to FIG. 3, the interworking network is generally composed of a wireless public network system 10 and a private network system 20.

Herein, the wired/wireless private network stands for a wireless private network, or a private network connected by wire and wireless.

The public network system 10 further includes an SMSC (SMS Center) 15 that controls SMS data.

Also, the private network system 20 further includes a private SMSC(SMS Center) 26 that controls SMS data, and an SMS route determination unit 20a that determines through which of the networks to transmit the SMS data.

The SMS route determination unit 20a can determine through which of the networks to transmit the SMS data using other route identifiers such as a terminating number, etc. which are included in SMS data that is transmitted from a transmission-side terminal 11.

As another method, a setup message indicating that SMS data from the transmission-side terminal 11 is to be transmitted through the private network is previously received and this information is stored in the private network system. Therefore, the SMS data generated later from the transmission-side terminal 11 can be transmitted by selection of the private or public network according to the information set up by the user.

Hereinafter, a procedure to actually transmit the SMS data from the transmission-side terminal in the foregoing configuration will be explained.

At first, when the transmission-side terminal MS 11 transmits the SMS data, this transmission signal is received at the private network system 20 within a coverage area.

The SMS route determination unit 20a in the private network system 20 determines through which of the networks to transmit the SMS data using the identifier included in the transmitted SMS data.

If it is determined through the identifier that the SMS is to be transmitted through the private network, the SMS data is transmitted to the private SMSC 26 and then normally to the reception-side terminal 40.

If it is determined through the identifier that the SMS is to be transmitted through the public network, the SMS data is transmitted to the SMSC 15 and then to the corresponding reception-side terminal through the public network.

Hereinafter, a description will be given according to a connection of the private network and the public network.

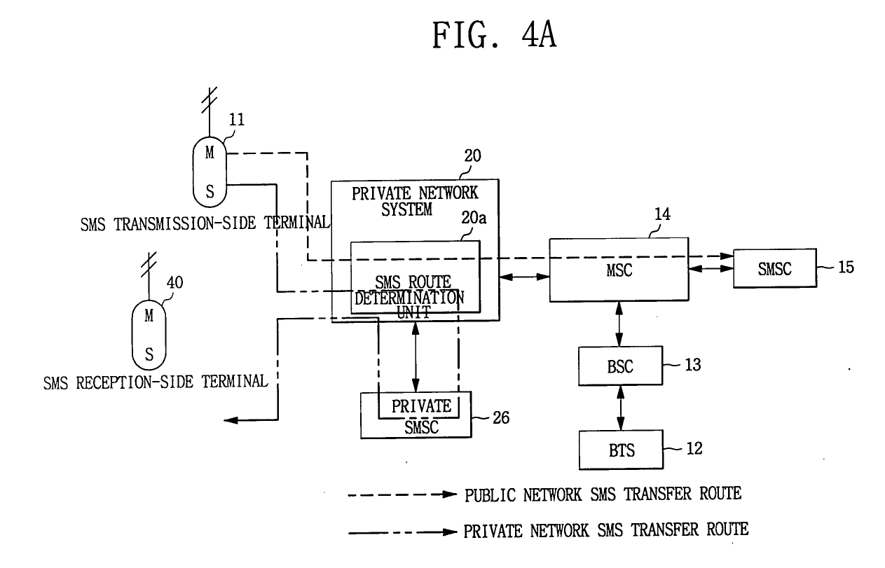

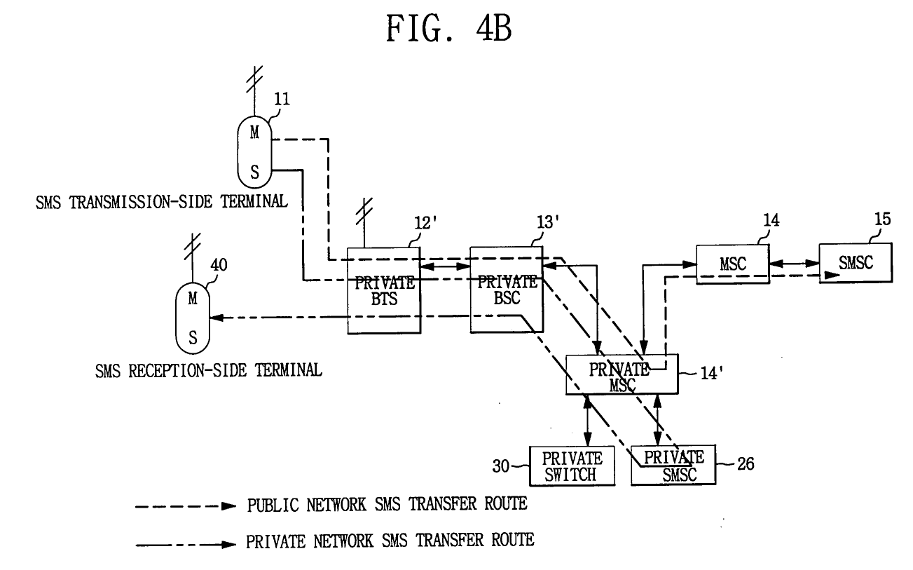

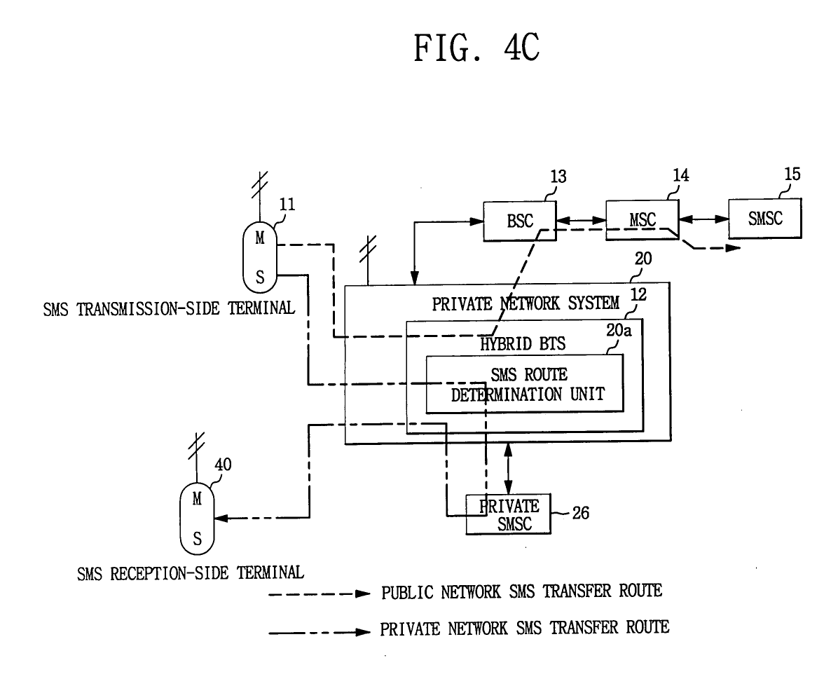

FIG. 4a is a block diagram schematically showing an SMS transfer route in a system where a private network is connected to a public network MSC stage, FIG. 4b is a block diagram concretely showing a system where a private network is connected to a public network MSC stage, and FIG. 4c is a block diagram showing an SMS transfer route in a network where a public network interworks with a private network through a hybrid BTS.

FIG. 4a is a view showing an embodiment for a system where a private network is 11 connected to a public MSC stage, which includes a BTS 12, a BSC 13, an MSC 14, and an SMSC 15 that are needed in using the private network system 20 and the public network.

The private network system 20 further includes a private SMSC (SMS Center) 26 for controlling the SMS data and an SMS route determination unit 20a for determining through which of the networks to transmit the SMS data.

The SMS route determination unit 20a can determine through which of the networks to transmit the SMS data using a terminating number included in the SMS data that is transmitted from the transmission-side terminal 11.

As another method, a setup message indicating that SMS data from the transmission-side terminal 11 is to be transmitted through the private network is previously received and this information is stored in the private network system. Moreover, as to SMS data occurring later from the transmission-side terminal 11, it is possible to select the private or public network and transmit the SMS data according to the information set up by the user.

FIG. 4b is a view concretely showing a system in which a private network is connected to a MSC stage of a public network, where the private network system 20 includes a private BTS 12′, a private BSC 13′ and a private MSC 14′, and the public network system includes the MSC 14 and the SMSC 15.

The private MSC 14′ is adapted to determine the route for the SMS data. Thereby, it is possible to determine through which of the networks to transmit the SMS data using route identifiers such as a terminating number, etc. that are included in the SMS data transmitted from the transmission-side terminal 11.

As another method, a setup message indicating that SMS message from the transmission-side terminal 11 is to be transmitted through the private network is previously received and this information is stored in the private MSC 14′. The SMS data generated later from the transmission-side terminal 11 can be transmitted by selection of the private or public network according to the information set up by the user.

In FIG. 4c, a BTS 12 is a hybrid BTS that includes a routing unit used to determine through which of a private network or a public network a call is transmitted. When the SMS data is received at the BTS 12, the SMS route determination unit 20a determines where to transmit the SMS data, and transmit the SMS data to the corresponding network.

Before explaining a concrete embodiment of the present invention, a constructional problem of the earlier art will be described.

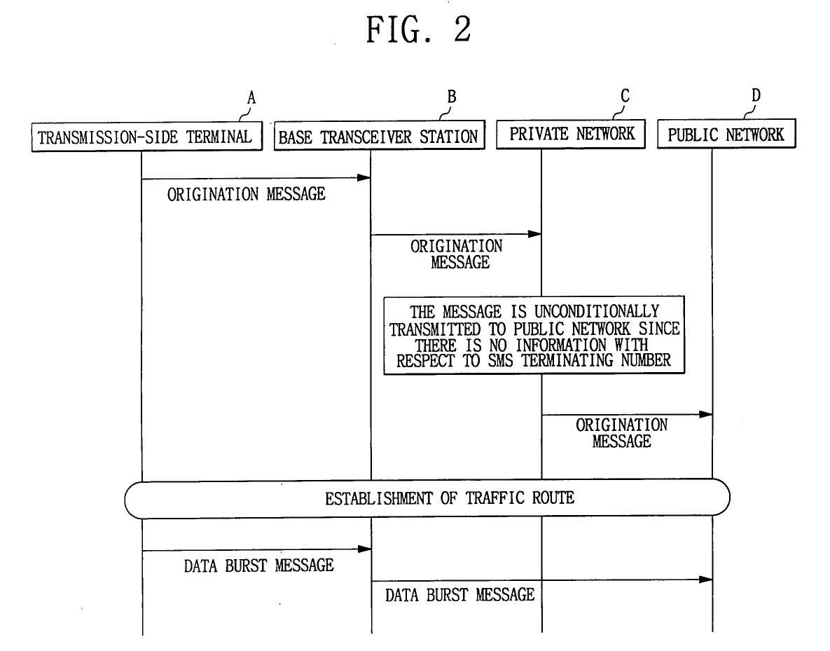

FIG. 2 is a block diagram schematically showing a process of transmitting a SMS in a conventional network where a wireless public network interworks with a wireless private network.

The transmission-side terminal generates an origination message according to a transmission input. At this point, the origination message is not provided with termination information. When the origination message is transmitted to the network, then a traffic route is established between the network and the terminal.

After the traffic route is established, the terminal generates a data burst message in which the termination information is embedded, and then transmits the generated message to the network.

More specifically, when the transmission-side terminal A transmits the SMS data, the origination message is received at the base transceiver station B first. The base transceiver station B transmits the received origination message to the private network C. At this time, since the origination message that is information received in the private network C for the first time does not have information on the terminating number, it is not possible to determine through which of the private network or the public network the SMS message is to be transmitted. Therefore, the private network C transmits the received origination message to the public network D.

Then, when the traffic route is established between the transmission-side terminal A and the public network D, the data burst message for actually transmitting the SMS data is transmitted.

The origination message is constructed as shown in Table 1.

TABLE 1

| Field | Bits | Description |
|---|---|---|
| MOB_TERM | 1 | |
| SLOT_CYCLE_INDEX | 3 | Slot period index |
| MOB_P_REV | 8 | Protocol change of terminal |
| SCM | 8 | Station class mark |
| REQUEST_MODE | 3 | Response mode code |
| SPECIAL_SERVICE | 1 | Special service indicator |
| SERVICE_OPTION | 0 or 16 | Service option |
| PM | 1 | Private mode indicator |
| DIGIT_MODE | 1 | Digit mode indicator |
| NUMBER_TYPE | 0 or 3 | Number type of digit mode |
| NUMBER_PLAN | 0 or 4 | Numbering plan |
| MORE_FIELDS | 1 | Indicator showing whether an |
| | | additional terminating number |
| | | exists |
| NUM_FIELDS | 8 | Terminating number |

Meanwhile, for a voice signal, a traffic channel is set up after it is determined to which network to be connected for a currently received call in the private network. By contrast, for the SMS data, the traffic channel is connected for the currently received call in the private network. Therefore, the SMS data is unconditionally transmitted through the public network.

In this case, since the SMS data to be transmitted through the private network is transmitted to the public network, the SMS data cannot be normally transmitted.

According to a specification of an existing terminal in view of texts described in a document TIA/EIA (Telecommunications Industry Association/Electronic Industries Association) standard specification 2.4.1.1.2.3 Traffic Channel Setup, when the terminal transmits the SMS data, the origination message is adapted to be transmitted without a terminating number.

Accordingly, such a problem can be solved when the private network SMS data is previously set up through which of the networks to be transmitted before it is transmitted, and then transmitting it normally.

The present invention suggests a method for setting up the private network SMS before transmitting the private network SMS data as a first embodiment.

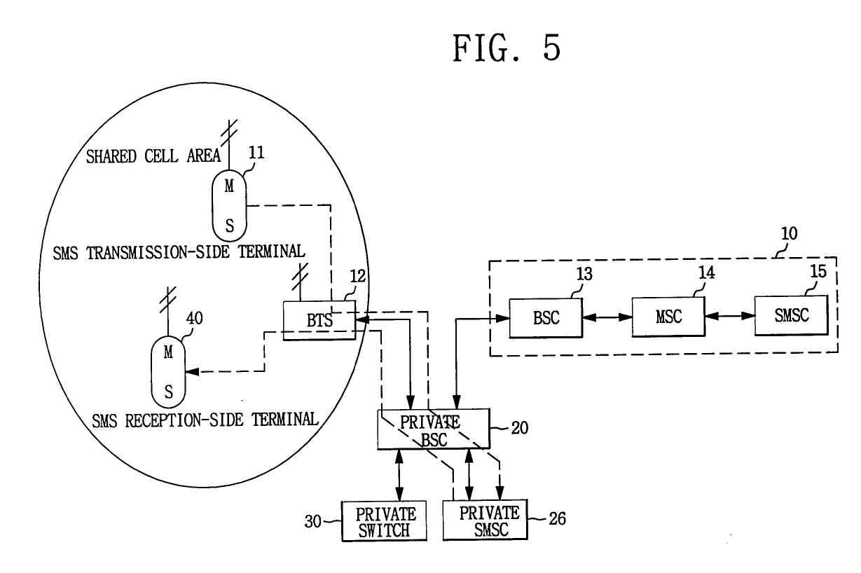

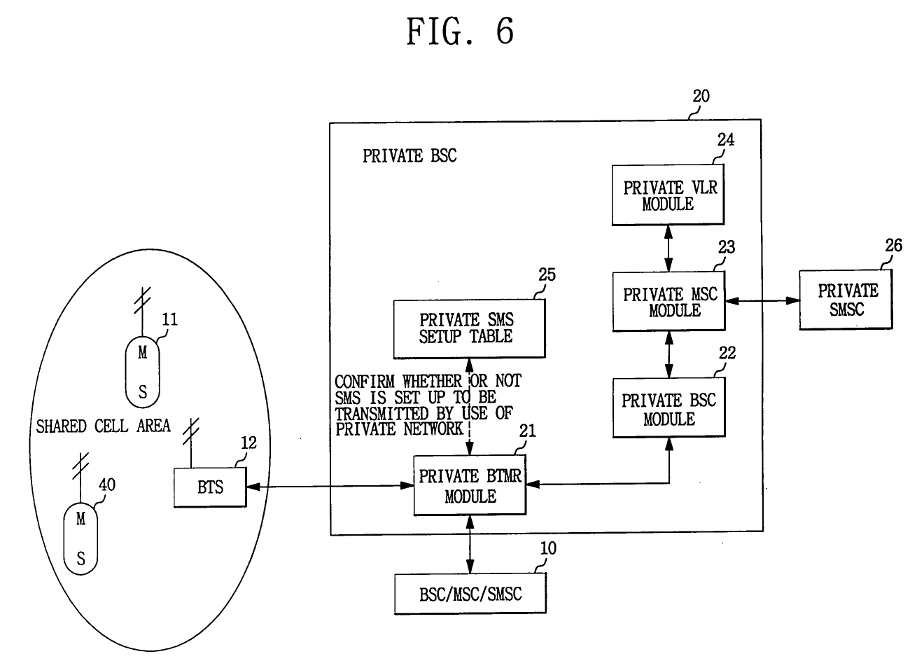

The first embodiment of the present invention to solve the problem will be explained with reference to FIGS. 5 and 6.

FIG. 5 is a block diagram schematically showing an SMS transfer route in a network where a private network is connected to a BSC stage of a wireless public network in accordance with a first embodiment of the invention, and FIG. 6 is a block diagram showing a control station of a private network shown in FIG. 5 in detail.

The network where a private network is connected to the BSC state of the wireless public network consists of a BTS 12, a private BSC 20, a private switch 30, a private SMSC 26 and a public network SMS processing unit 10.

The BTS 12 sets up a cell coverage supporting a public network and a wireless private network as its own cell area.

The shared cell area is described in detail in Korean Patent Registration No. 10-0365790.

The public network SMS processing unit 10 includes a BSC 13, an MSC 14 and an SMSC 15, the BSC 13 performs functions of a wireless link control and a handoff, and the MSC 14 performs call resource management. The SMSC 15 is an SMS data management center.

The MSs 11 and 40 exist within the shared cell area where the public network is shared with the private network, and are service-registered to receive a private network service.

As shown in FIG. 6, the private BSC 20 includes a private BTMR (BTS (Base Transceiver Station) Message Router) module 21, a private BSC module 22, a private MSC module 23, a private VLR module 24 and a private SMS setup table 25.

The private BTMR module 21, the private BSC module 22, the private MSC module 23 and the private VLR (Visitor Location Register) module 24 are software blocks divided into each function, which are not divided in hardware.

The private BTMR module 21 retrieves for the private SMS setup table 25 to determine whether the SMS data received from the BTS 12 is one of using the private network, and performs a function (routing) to transfer the SMS data to the corresponding network according to a result of the information.

The private BSC module 22 can perform functions corresponding to the BSC in the public network, that is, the wireless link control and the handoff.

The private MSC module 23 can perform the call resource management and information change of the SMS setup table 25.

The private VLR module 24 has location information of a terminal and can perform information change function of the private SMS setup table 25.

The present invention is not limited to fixed functions among the private BTMR module 21, the private BSC module 22, the private MSC module 23 and the private VLR module 24, and can be changed into the most preferred form at any time when some function is determined to be needed.

When an arbitrary Mobile Station 11 transmits a short message service (hereinafter, referred to as SMS) data, the BTS 12 in the corresponding region receives the SMS data and matches the data with the private BSC 20. The private BSC 20 determines through which of the networks (the private network or the public network) the SMS data is to be transmitted. When the SMS data is transmitted through the private network, the private BSC 20 transmits the SMS data to the private SMSC (SMS Center) 26. However, when the SMS data is transmitted through the public network, the private BSC 20 transmits the SMS data to the public network SMS processing unit 10.

The private BSC 20 includes a private BTMR module 21 for determining an SMS route for an SMS originating ID (identification) with reference to a database and transmitting the SMS originating ID to the corresponding network (the private network/the public network), a private BSC module 22 for managing a plurality of base transceiver station and processing a wireless channel setup and a frequency hopping, a private MSC module 23 for exchanging signals, a private Visitor Location Register (VLR) module 24 for storing location information of a terminal, and a private SMS setup table 25 composed of a SMS route information field corresponding to the ID of the transmission-side terminal.

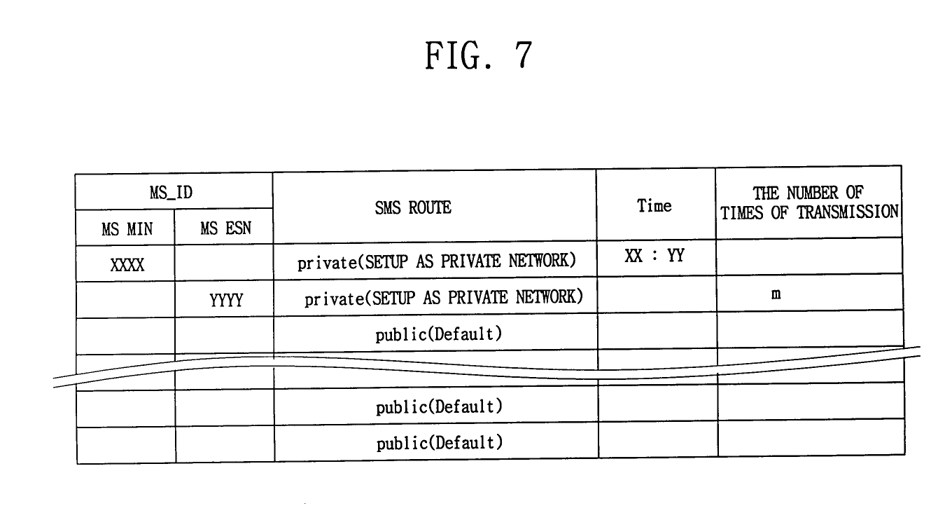

FIG. 7 is a table for a database having data indicating whether an SMS is transmitted through a private network. Referring to FIG. 7, the private SMS setup table 25 includes a time field indicating a time when a user wishes to use the network, and a field for the transmission number of times indicating how many times the user wishes to use the network, inclusive of a transmission-side terminal ID (identification) field and an SMS route field.

Although the present invention will take an MIN (Mobile Identification Number) and an ESN (Electronic Serial Number) as an example of the transmission-side terminal ID, the transmission-side terminal ID field additionally includes an International Mobile Subscriber Identity (IMSI) and a Temporary Mobile Subscriber Identity (TMSI).

Here, the MIN is a terminal phone number, which can be expressed as 10 digits of decimal. Moreover, the ESN is a divider assigned to the terminal, which is assigned 8 bits.

While the terminal ID expression methods are different according to kinds of terminals, one of MIN, ESN, IMSI and TMSI may be recognized as the terminal ID.

The private SMS setup table 25 may be included in the private VLR module 24, or in one of the private MSC module 23, the private BTMR module 21 and the private BSC module 22. Also, the private SMS setup table 25 may be constructed with a separate database.

When the SMS route field has an initial setup (default) designated as the public network, and when the SMS data is intended to pass through the private network, a setup to use the private network should be performed previously.

On the other hand, when the initial setup (default) of the SMS route field is designated as the private network, and when the SMS data is intended to pass through the public network, a setup to use the public network should be performed previously.

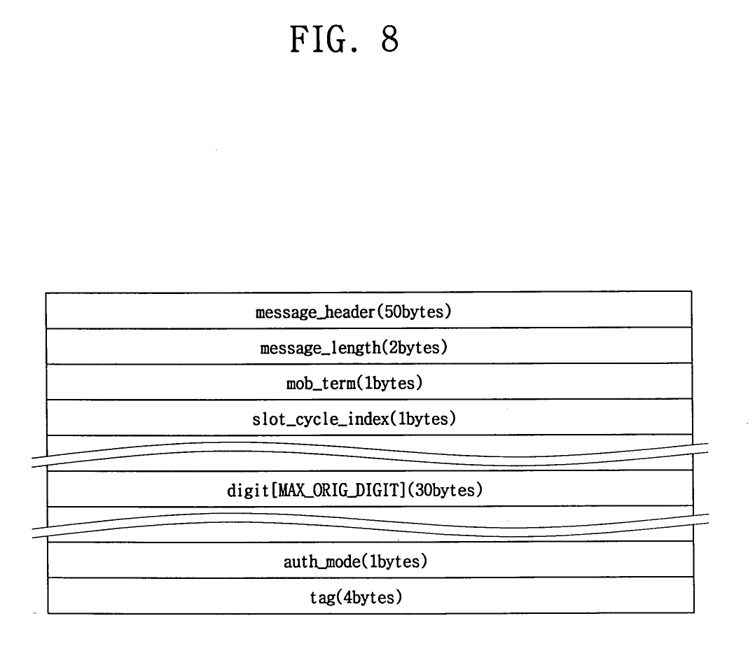

FIG. 8 is a view showing a basic structure of a transmission message to establish a private network route.

Referring to FIG. 8, a basic structure of a transmission message that is received from the transmission-side terminal into the private BTMR module 21 of the private BSC 20 includes a message header, a message length, and digit [MAX_ORIG_DIGIT] information which a user sets up with terminal button keys.

In order that the user transmits the SMS through the private network in the state of the construction as described above, a process for setting up the private network SMS should be performed for the first time.

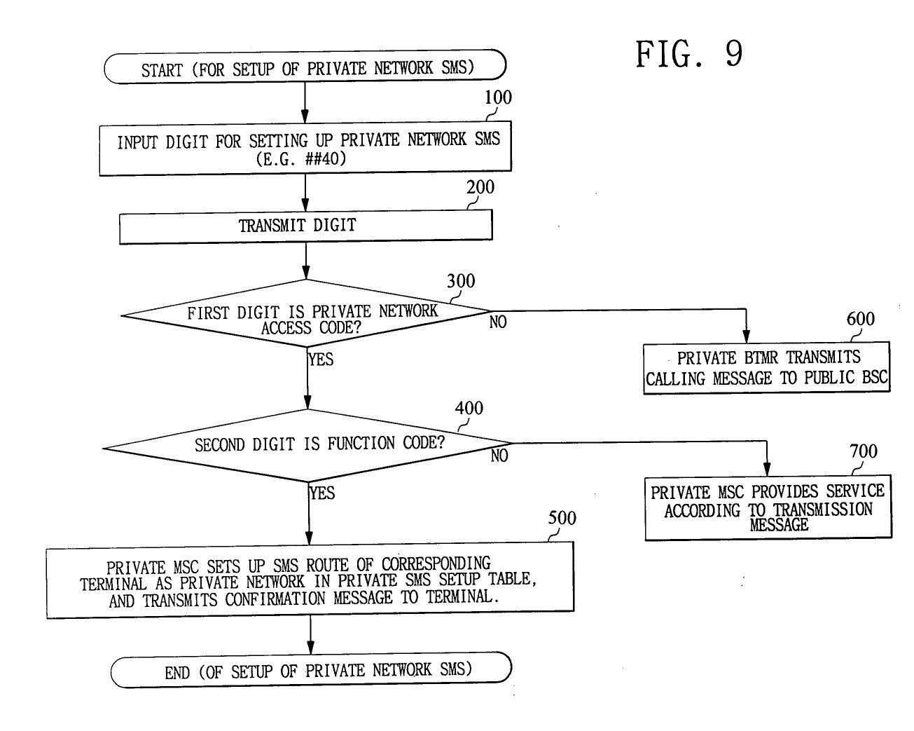

FIG. 9 is a flow chart of a process for setting up a private network SMS by a user in accordance with an embodiment of the present invention.

Referring to FIG. 9, a process for setting up the private network SMS by use of the private network will be explained under the assumption that a characteristic code for setting up the private network SMS is 40.

Herein, a private network access code is defined as “#,” and a function access code is also defined as “#.” However, these codes may be defined as another value. Then, the value may be used. That is, if these codes are defined as “*” or another number key, this may be used.

As to each characteristic code, a code value used to set up the private SMS is defined as 40, a code value used to release the private SMS is defined as 44, a code value used to set up the private SMS time is defined as 41+time (xxxx), and a code value used to set up the number of times to transmit the private SMS is defined as 42+the number of times (xx). However, it should be noted that the code values may be defined and used as other numbers.

The code values of the private network access code, the function access code and the characteristic code are stored in the database of the private network control station, and are adapted to perform functions of the corresponding codes according to dial digit values transmitted from an arbitrary transmission-side terminal.

The dial digit values are recorded in the digit [MAX_ORIG_DIGIT] field of the transmission message format shown in FIG. 8.

In the following description, the first # of a dial digit which is set up by the user is stored in the database of the private network control station.

At first, the digit “##40” is inputted using a button key of the terminal and the digit is transmitted by pushing a connection button (steps 100 and 200).

TABLE 2

| # | Private access code |
|---|---|
| # | Function access code |
| 40 | Characteristic code (setting up the private network SMS) |

At this time, in the transmission message, a digit is inputted into the digit [MAX_ORIG_DIGIT] as shown in FIG. 8.

The function setup transmission message is transmitted to the private BTMR module 21, and determines whether the private network is serviced through the first digit (300).

When the first digit is one of general numbers, this means a connection code for the public network rather than a connection code for the private network, so that the private BTMR module 21 transmits a current calling message to the public BSC (600).

Although the present invention provides an example where the private BTMR module 21 performs a message transmission function, the private BSC module 22, the private MSC module 23 and the private VLR module 24 can set to perform the message transmission function.

However, when the first digit is determined to be “#” in step 300, the digit means the private network connection code, and thus it is determined whether the second digit is a function code (400).

When the second digit is determined not to be “#” but to be one of the general numbers, a separate function setup is not performed while the private network is connected. Thus, the private MSC module 23 transmits the transmission message to a reception-side terminal (step 700). The private MSC module 23 provides service according to the transmission message.

When the second digit is determined to be “#” in step 400, it is the case that the user wishes to set up a separate function. So, in order to set up a private SMS according to a digit “40” following the second digit, the private MSC module 23 sets an SMS route field of the corresponding terminal as an private network in the private SMS setup table 25 and transmits a confirmation message to the terminal (500).

The present invention provides an example where the private MSC module 23 sets the SMS route in the private SMS setup table 25. In addition, the private BTMR module 21, the private BSC module 22 and the private VLR module 24 may set the SMS route.

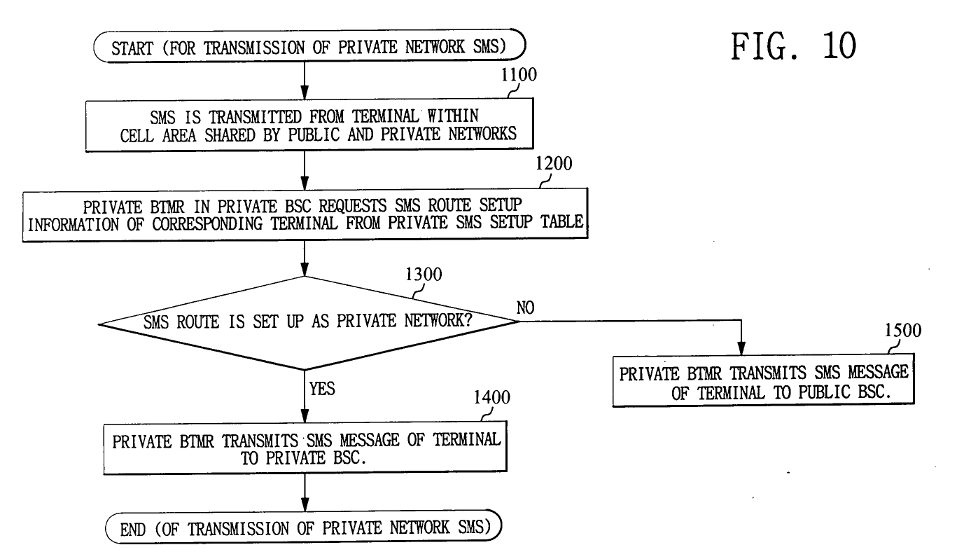

A process of transmitting an SMS to the private network will be explained with reference to FIG. 10.

FIG. 10 is a flow chart showing a process where a user transmits an SMS to a reception-side terminal through a private network in accordance with an embodiment of the present invention.

When a terminal within a cell area shared by the public and private networks transmits the SMS (1100), the BTMR module 21 in the private BSC requests SMS route setup information of the corresponding terminal from the private SMS setup table 25 (1200).

It is determined whether a private network is set up in the private SMS route field corresponding to the transmission-side terminal ID with reference to setup information (1300).

When the private network SMS route field corresponding to the transmission-side terminal ID (identification) is set up as the private network in step 1300, the private BTMR module 21 transmits the SMS message originated from the corresponding transmission-side terminal to the private BSC module 22 (step 1400).

When the private SMS route field corresponding to the transmission-side terminal ID is set up as the public network in step 1300, the private BTMR module 21 transmits the SMS message originated from the corresponding transmission-side terminal to the public BSC 13 (1500).

Although the present invention provides an example where the private BTMR module 21 performs a message transmission function, the private BSC module 22, the private MSC module 23 and the private VLR module 24 can also set up the function.

When an arbitrary terminal sets up the private network SMS as described above, this terminal transmits the SMS data through a private network until the setup is released.

Accordingly, there is a need for a method of releasing the setup of the private network SMS in consideration of the case that a user transmits the SMS through a public network.

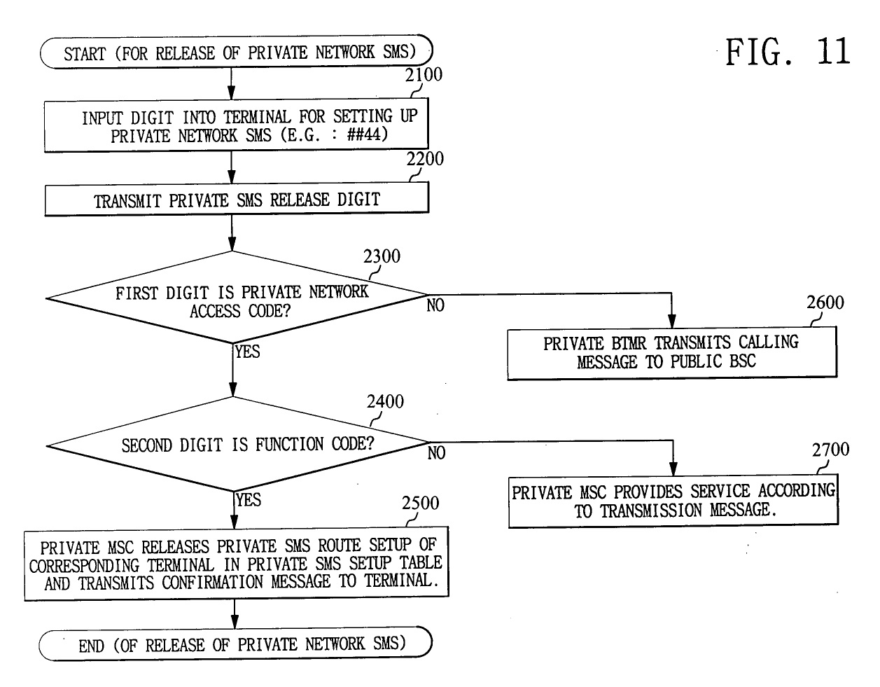

FIG. 11 is a flow chart showing a process of releasing a private network SMS transmission function in accordance with an embodiment of the present invention.

A description will be given on the assumption that a characteristic code to release the private network SMS is 44, with reference to FIG. 11.

At first, a digit “##44” is inputted using a button key of a terminal, and the digit is originated by pushing a connection button (2100, 2200).

The meaning of the “##44” is shown in Table 3.

TABLE 3

| # | Private network access code |
|---|---|
| # | Function access code |
| 44 | Characteristic code (private network SMS setup release) |

At this time, a digit is inserted into digit [MAX_ORIG_DIGIT] in the transmission message as shown in FIG. 8.

The function setup transmission message is transmitted to the private BTMR module 21, and it is determined whether a private network service is provided through the first digit (2300).

When the first digit is one of general numbers (not a private network access code), since it means a public network connection, not a private network connection, the private BTMR module 21 transmits a current call message to the public network BSC 13 (2600).

Although the present invention provides an example where the private BTMR module 21 performs the message transmission function, the private BSC module 22, the private MSC module 23 and the private VLR module 24 can also set up the function.

However, when the first digit is determined to be “#” in step 2300, since it is the private network connection code, it is determined whether the second digit is a function code (2400).

When the second digit is determined not to be “#” but to be one of the general numbers, a separate function setup is not performed while the private network is connected. Thus, the private MSC module 23 transmits the transmission message to a reception-side terminal (2700).

When the second digit is determined to be “#” in step 2400, it is the case that the user wishes to set up a separate function. So, in order to set up a private SMS according to a digit “44” following the second digit, the private MSC module 23 changes an SMS route field of the corresponding terminal to a public network in the private SMS setup table 25 and transmits a confirmation message to the terminal (2500).

The present invention provides an example where the private MSC module 23 sets up the SMS route in the private SMS setup table 25. However, the private BTMR module 21, the private BSC module 22 and the private VLR module 24 may set up the SMS route.

Accordingly, after the setup of the SMS is released, the SMS data transmitted from this terminal passes through the public network until the private network is set up again.

Meanwhile, while FIG. 9 explains the case of setting up the private network SMS, the user can automatically release the setup of the private SMS when the user wishes to do so without separately releasing the setup of the private network SMS for the convenience of the user.

Hereinafter, an explanation will be given to the case that the private network SMS is automatically released when a predetermined time has lapsed.

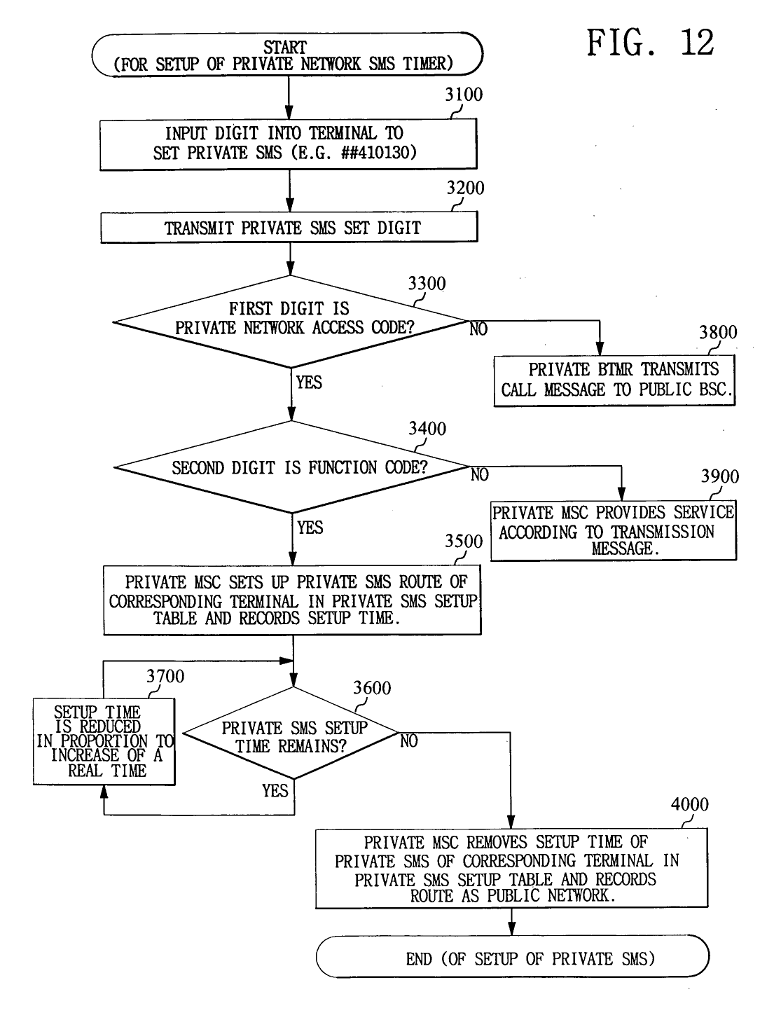

FIG. 12 is a flow chart showing a process of setting up and releasing a private network SMS transmission function using a timer in accordance with an embodiment of the present invention.

An explanation will be given on the assumption that a characteristic code to set up the private network SMS timer is “41” and the setup time is 1 hour and 30 minutes, with reference to FIG. 12.

At first, a digit “##410130” is inputted and a connection button is pushed to originate the digit using a button key of a terminal (3100, 3200).

The meaning of “##410130” is shown in Table 4.

TABLE 4

| # | Private network access code |
|---|---|
| # | Function access code |
| 41 | Characteristic code (time setup of private network SMS) |
| 0130 | Setting up 1 hour and 30 minutes |

At this time, a digit is inserted into the digit [MAX_ORIG_DIGIT] in the transmission message as shown in FIG. 8.

The function setup transmission message is transmitted to the private BTMR module 21, and it is determined whether a private service is provided through the first digit (3300).

When the first digit is one of general numbers, this means a connection code for the public network rather than a connection code for the private network. Thus, the private BTMR module 21 transmits a current call message to the public network BSC (3800).

Although the present invention provides an example where the private BTMR module 21 performs the message transmission function, the private BSC module 22, the private MSC module 23 and the private VLR module 24 can also set up the function.

However, when the first digit is determined to be “#” in step 3300, since it is the private network connection code, it is determined whether the second digit is a function code (3400).

When the second digit is determined not to be “#” but to be one of the general numbers in step 3400, a separate function setup is not performed while the private network is connected. Thus, the private MSC module 23 transmits the transmission message to a reception-side terminal (3900).

When the second digit is determined to be “#” in step 3400, it is the case that the user wishes to set up a separate function. So, in order to set up a private SMS and time according to a digit “410130” following the second digit, the private MSC module 23 sets an SMS route field of the corresponding terminal as a public network in the private SMS setup table 25 and records a setup time in a time field (3500).

It is determined whether the private network SMS setup time recorded in the time field of the private SMS setup table 25 remains or not (step 3600).

When the setup time does not remain in step 3600, the private MSC module 23 removes the setup time recorded in the time field of corresponding terminal in the private SMS setup table 25, and changes the SMS route field of the corresponding terminal to the public network (step 4000).

The present invention provides an example where the private MSC module 23 performs setup operation such as the SMS route setup, the time setup, the setup time removal and so forth, but the private BTMR module 21, the private BSC module 22 and the private VLR module 24 may also perform the setup operation.

When the setup time remains in step 3600, the setup time is reduced in proportion to increase of a real time with respect to the time recorded in the time field of the private SMS setup table 25 (3700).

Accordingly, when the private network SMS setup is accomplished, time is set up so that the SMS data transmitted from this terminal within the corresponding time passes through the private network, and the SMS data transmitted after the setup time has lapsed passes through the public network since the setup time recorded in the time field is removed.

Hereinafter, an explanation will be given to the case where the number of times of the private SMS transmission is set up and the SMS transmission setup is automatically released when the setup number of times is reached.

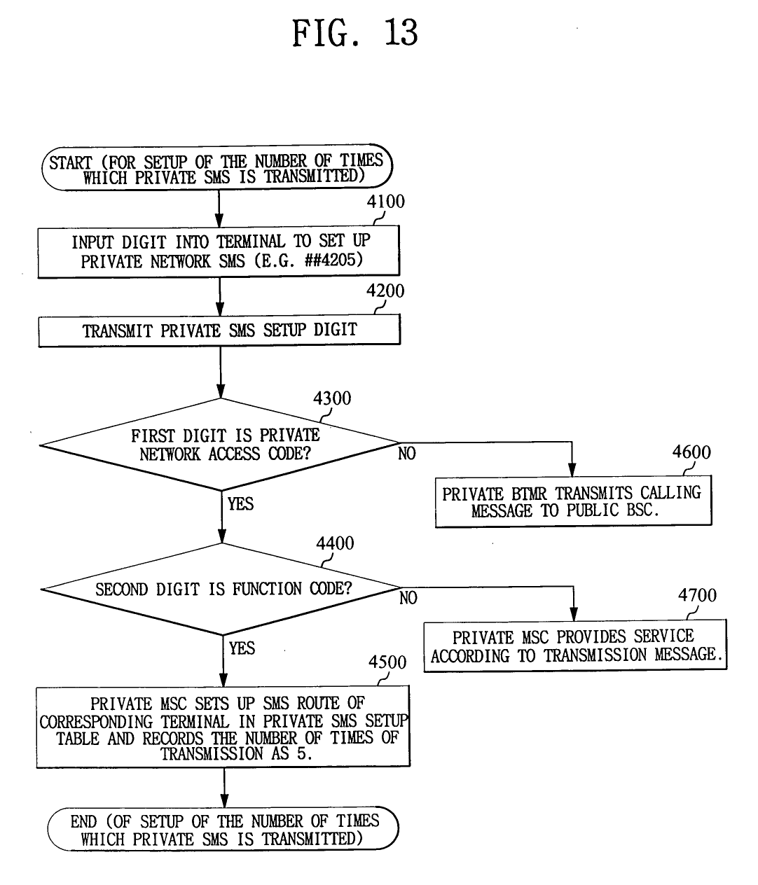

FIG. 13 is a flow chart showing a process of assigning and setting up the number of times of originating transmission with respect to a private network SMS transmission function in accordance with an embodiment of the present invention.

An explanation will be given on the assumption that a characteristic code to set up the number of times of the private network SMS transmission is 42 (forty-two), and the transmission number of times is 5 (five), with reference to FIG. 13.

At first, a digit “##4205” is inputted using button keys of a terminal, and the digit is originated by pushing a connection button (4100, 4200).

The meaning of the “##4205” is shown in Table 5.

TABLE 5

| # | Private network access code |
|---|---|
| # | Function access code |
| 42 | Characteristic code (setting up the number of times |
| | to transmit the private network SMS) |
| 05 | 5 times |

At this time, a digit is inserted into the digit [MAX_ORIG_DIGIT] in the transmission message as shown in FIG. 8.

The function setup transmission message is transmitted to the private BTMR module 21, and it is determined whether a private network service is provided through the first digit (4300).

When the first digit is one of general numbers and not the private network access code, this means a connection code for the public network rather than a connection code for the private network, so that the private BTMR module 21 transmits a current call message to the public network BSC (4600).

Although the present invention provides an example where the private BTMR module 21 performs the message transmission function, the private BSC module 22, the private MSC module 23 and the private VLR module 24 can also set up the function.

Meanwhile, when the first digit is determined to be “#” in step 4300, since it is the private network connection code, it is determined whether the second digit is a function code (4400).

When the second digit is determined not to be “#” but to be one of the general numbers, a separate function setup is not performed while the private network is connected. Thus, the private MSC module 23 transmits the transmission message to a reception-side terminal (4700).

When the second digit is determined to be “#” in step 4400, it is the case that the user wishes to set up a separate function. So, in order to set up a private SMS route and the number of times of transmission transmissions according to a digit “4205” following the second digit, the private MSC module 23 sets up an SMS route field of the corresponding terminal as a public network in the private SMS setup table 25 and records the setup number of times (5 times) in the field for the transmission number of times (4500).

The present invention provides an example where the private MSC module 23 sets up the SMS route and the transmission number of times in the private SMS setup table 25, but the private BTMR module 21, the private BSC module 22 and the private VLR module 24 may also set up them.

Accordingly, the user can transmit the SMS through the private network 5 times using this terminal. Whenever the SMS data is transmitted, the number of times recorded in the field for the transmission number of times in the private SMS setup table 25 is reduced by 1.

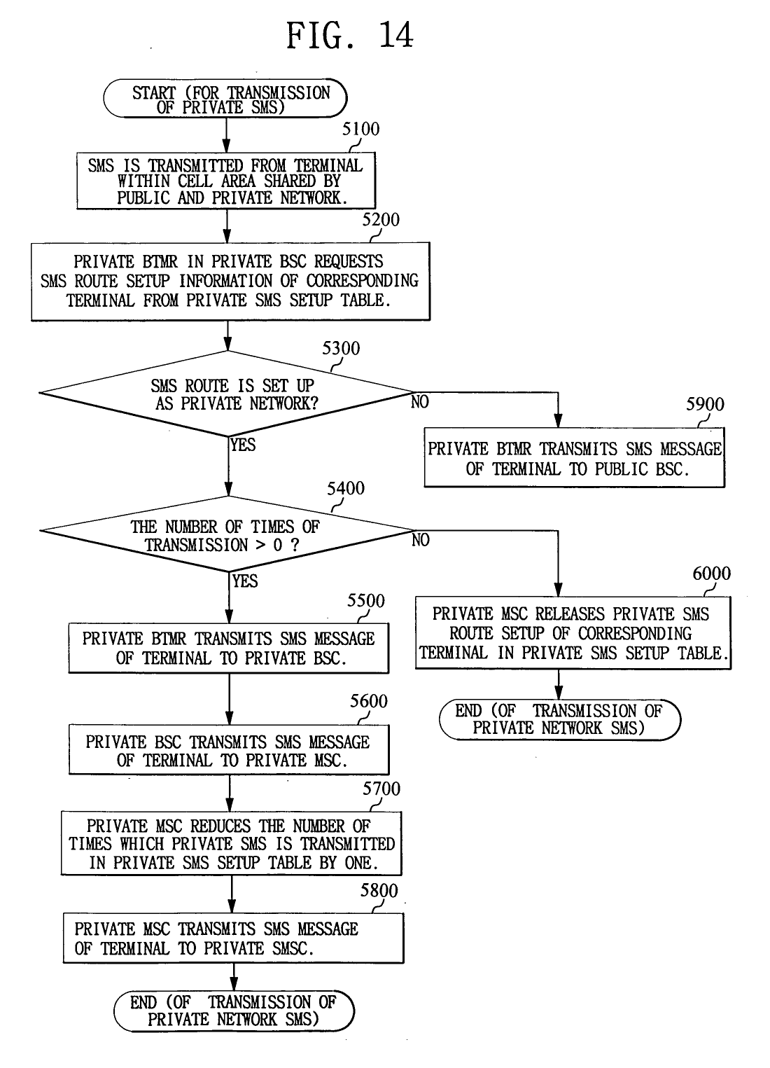

Hereinafter, an explanation will be given to the case that the user actually transmits the SMS using a terminal in the state that the number of times of the private network SMS originating transmission is set up with reference to FIG. 14.

FIG. 14 is a flow chart showing a process of transmitting a private SMS in the state that the number of times of the SMS transmission is set in accordance with an embodiment of the present invention.

At first, when a terminal within a cell area shared by a public network and a private network transmits an SMS (5100), the private BTMR module 21 in the private BSC requests the SMS route setup information of the corresponding terminal in the private SMS setup table 25 (5200).

It is determined whether the private SMS route field corresponding to the transmission-side terminal ID is set up as the private network (5300) with reference to the setup information.

When the private network SMS route field corresponding to the transmission-side terminal ID is set up as the public network in step 5300, the private BTMR module 21 transmits the SMS message originated from the corresponding transmission-side terminal to the public BSC 13 (5900).

Although the present invention provides an example where the private BTMR module 21 performs a message transmission function, the private BSC module 22, the private MSC module 23 and the private VLR module 24 can also set up the function.

When the private SMS route field corresponding to the transmission-side terminal ID is set up as a private network in step 5300, it is determined whether the number of times recorded in the field for the transmission number of times in the private SMS setup table 25 is over 0 (zero) (step 5400).

When the number of times of transmission is over 0 in the step 5400, the private BTMR module 21 transmits the SMS message originated from the corresponding transmission-side terminal to the private BSC module 22 (5500).

The SMS data transmitted to the private BSC module 22 is transmitted to the private MSC module 23 to be switched to a terminal of the other party (step 5600).

After the private SMS module 23 reduces the number of times recorded in the field for the transmission number of times in the private SMS setup table 25 (5700), the private MSC module 23 transmits the SMS data of the terminal to the private SMSC 26 (5800).

However, when it is determined that the transmission number of times is 0 in step 5400, since the SMS data transmitted later cannot pass through the private network, the private MSC module 23 changes the private SMS route setup of the corresponding terminal to the public network in the private SMS setup table 25 (6000).

Although the present invention provides an example where the private MSC module 23 performs the SMS route setup in the private SMS setup table 25, the private BTMR module 21, the private BSC module 22 and the private VLR module 24 can also set up the route.

Accordingly, when the private network SMS setup and the setup of the transmission number of times are completed as shown in FIGS. 11 and 12, the SMS data transmitted from the terminal passes through the private network until the number of times of the corresponding transmission is completed. In addition, when the number of the transmission is completed, the number of times recorded in the field for the transmission number of times becomes 0 and the SMS data transmitted at this time passes through the public network.

Meanwhile, the functions for setting up the private SMS timer and the number of times of the private SMS transmission may be combined with each other and additional functions may be added in the private SMS setup table as option items when necessary, even though those were not suggested in the above examples of the present invention.

When the user attempts to transmit the SMS, the private network system transmits various information, which are related to the SMS transmission and set up in the private SMS setup table, such as private network setup situation, remaining number of times of transmission, remaining time and so forth. Thereby, the user is allowed to know the current information set up.

In this manner, the user can easily know through which of the networks the terminal transmits the SMS by the various information related to the SMS transmission. For example, under the situation where the private network is set up for transmission, the user can know how many and far the SMS can be transmitted through the private network. As a result, it is possible to maximize the convenience of the user.

Further, the problem that the information on a terminator or receiver is not included in the SMS data when the SMS data is transmitted in the existing terminal specification can be solved by upgrading software for the terminal (terminal specification change).

The present invention suggests a method for supporting a private network SMS through a terminal specification change as a second embodiment.

In the second embodiment, the digit field of the origination message of Table 1 is adapted to be recorded by the private network code (herein, defined as “#”) indicating that the SMS is transmitted through the private code and by the terminating number, before the phone number of the counterpart who is intended to receive the SMS. A structure of the origination message is given in Table 6.

TABLE 6

| Field | Length (Bits) | Description |
|---|---|---|
| MOB_TERM | 1 | |
| SLOT_CYCLE_INDEX | 3 | Slot period index |
| MOB_P_REV | 8 | Protocol change of terminal |
| SCM | 8 | Station class mark |
| REQUEST_MODE | 3 | Response mode code |
| SPECIAL_SERVICE | 1 | Special service indicator |
| SERVICE_OPTION | 0 or 16 | Service option |
| PM | 1 | Private mode indicator |
| DIGIT_MODE | 1 | Digit mode indicator |
| NUMBER_TYPE | 0 or 3 | Number type of digit mode |
| NUMBER_PLAN | 0 or 4 | Numbering plan |
| MORE_FIELDS | 1 | Indicator showing whether an |
| | | additional terminating |
| | | number exists |
| NUM_FIELDS | 8 | Terminating number |
| DIGIT | 30 × 8 | #xxxx |

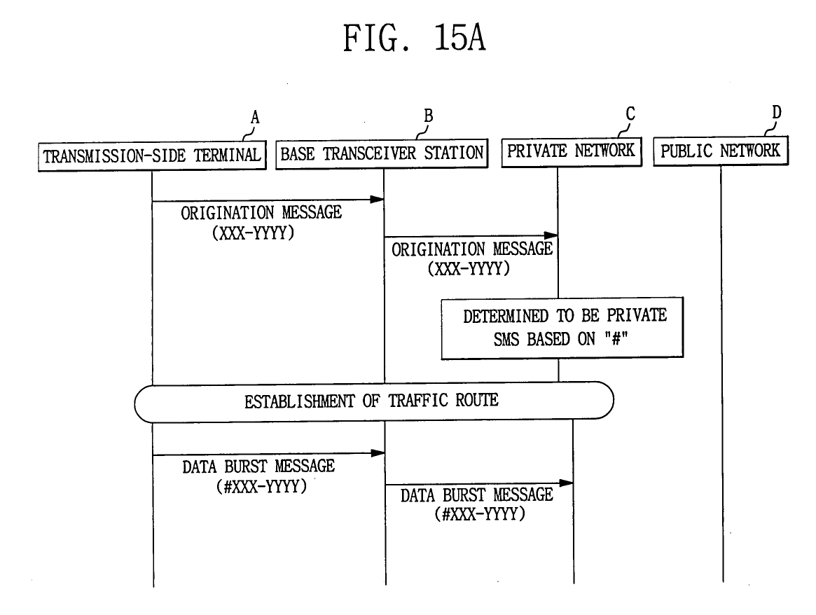

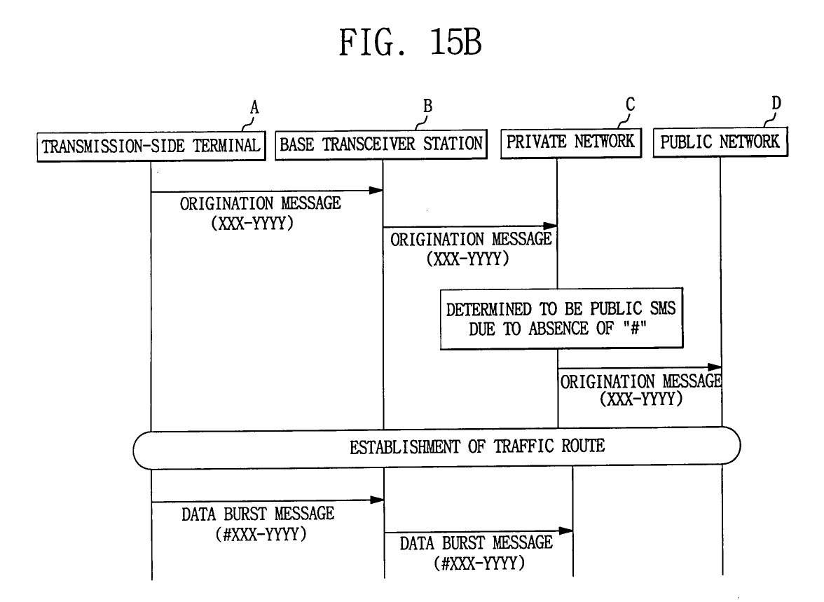

The second embodiment of the present invention will be explained with reference to FIGS. 15a and 15b.

FIG. 15a is a view showing a process of upgrading software of each terminal and transmitting the SMS through a private network in accordance with a second embodiment of the present invention, and FIG. 15b is a view showing a process of upgrading software of each terminal and transmitting the SMS through a public network in accordance with a second embodiment of the present invention.

At first, for the process of transmitting the SMS through the private network with reference to FIG. 15a, when the transmission-side terminal A transmits the SMS data to be transmitted through private network using an terminating number #xxxx, the origination message including the terminating number #xxxx is received at the base transceiver station B. The base transceiver station B transmits the received origination message to a private network C, thereby permitting a traffic route to be established. In this case, the origination message that the private network C receives for the first time is transmitted together with a terminating number #xxxx.

Although the present invention defines the private network access code as “#” in the terminating number included in the origination message, when the code is defined as another value, that value may be used. That is, when the code is defined as “*” or other number key, they may be used.

Since the private network C has “#” in the first digit, the data is determined to be the SMS data to be transmitted though the private network. The traffic route is established between the transmission-side terminal A and the private network C, and then the data burst message for the actual SMS data is transmitted to the private SMSC.

Accordingly, the data to pass through the private network is normally transmitted to the reception-side terminal immediately after being transmitted to the private SMSC.

Meanwhile, the public network passing SMS transmission process is as follows. When the reception-side terminal A originates the public network passing SMS data to a terminating number xxx-yyyy, the origination message including the terminating number xxx-yyyy is received in the base transceiver station B. The base transceiver station B transmits the receive origination message to the private network C, where the origination message of information that the private network C received for the first time is transmitted while the information includes the terminating number xxx-yyyy.

Since the private network C does not have “#” in the first digit, the data is determined to be the SMS data to be transmitted though the public network. The origination message is transmitted to the public network D, so that the traffic route is established. Then, the data burst message for the actual SMS data is transmitted to the public SMSC.

Accordingly, the SMS data to be transmitted through the public network is normally transmitted to the reception-side terminal after being transmitted to the public SMSC.

A structure of the data burst message is given as in Table 7.

TABLE 7

| Field | Length (Bits) | Description |
|---|---|---|
| msg_number | 8 | |
| burst_type | 6 | “000011” for “SMS” |
| num_msgs | 8 | |
| num_fields | 8 | |
| mobile_country_code | 10 | |
| country_burst_type | 6 | |
| chari | 200 × 8 | xxx-yyyy |

Meanwhile, when the specification of the terminal is changed, the terminal is fabricated so as to display various information, such as the network through which the SMS is transmitted, remaining number of times of transmission, remaining time and so forth, on a (liquid crystal) display. Thereby, the user is allowed to know through which of the networks the terminal transmits the SMS by the various information related to the SMS transmission.

Further, under the situation where the private network is set up for transmission, the user can know how many and far the SMS can be transmitted through the private network. As a result, it is possible to maximize the convenience of the user.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

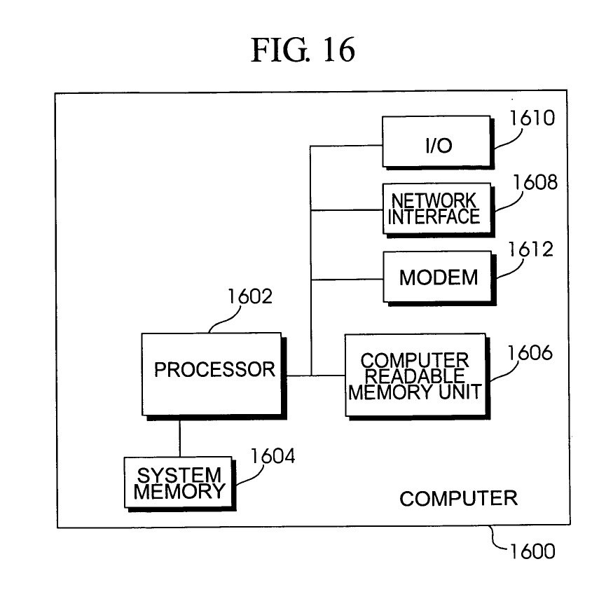

An example of a computer, but not limited to this example of the computer, that can read computer readable media that includes computer-executable instructions of the present invention is shown in FIG. 16. The computer 1600 includes a processor 1602 that controls the computer 1600. The processor 1602 uses the system memory 1604 and a computer readable memory device 1606 that includes certain computer readable recording media. A system bus connects the processor 1602 to a network interface 1608, modem 1612 or other interface that accommodates a connection to another computer or network such as the Internet. The system bus may also include an input and output interface 1610 that accommodates connection to a variety of other devices.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

As described above, since it is possible to transmit SMS data through any one selected from the public network and the private network in the network interworking between the wireless public and the wired/wireless private network in accordance with the present invention, the user can be provided with convenience.

Also, since the SMS data can be transmitted to the private network by upgrading software of the system without changing the hardware and software from the terminal of each user, no additional expense is incurred.

1. A method for providing a short message service in a network interworking between a wireless public network and a wired and wireless private network, comprising:
setting up an identifier to determine through which of said public and private networks to transmit the short message service; and
retrieving the transmitted identifier of a terminal and transmitting the short message service to a corresponding network according to retrieved information.

2. A method for providing a short message service in a network interworking between a wireless public network and a wired and wireless private network, comprising:
setting up, by a user, through which of said public and private networks to transmit the short message service;
storing information set up by the user in a private network database; and
when an arbitrary user transmits the short message service, retrieving an identifier of a terminal of the arbitrary user from the private network database, and providing the short message service through a corresponding one of said public and private networks depending on a status set up in said private network database.

3. The method according to claim 2, further comprising of releasing a function of setting up the short message service through said private network.

4. The method according to claim 2, wherein said step of retrieving an identifier of said terminal of the arbitrary user and providing the short message service includes informing information on setup situation of the short message service before the short message service is transmitted through the corresponding network depending on the status set up in the private network database after the identifier of the terminal of the arbitrary user is retrieved from the private network database as the arbitrary user transmits the short message service.

5. The method according to claim 4, with said setup situation comprising network for transmission, the number of times of transmission, and remaining time.

6. The method according to claim 2, wherein said step of setting up, by the user is performed by the user inputting and setting up digits using button keys of a wireless terminal.

7. The method according to claim 6, wherein the digits are combined with a private network access code, a function access code and a characteristic code.

8. The method according to claim 7, wherein said characteristic code including a private network short message setup function code.

9. The method according to claim 2, wherein the step of storing information set up by the user in the private network database is performed by transmitting short message service data received through the base transceiver station together with the identifier of the corresponding user's terminal to a private network control station, and referring to a field for a private network route set up in each entry of a service setup table of the private network short message service in said database of the private network control station.

10. The method according to claim 3, wherein said step of releasing the function of setting up the short message service is performed by the user inputting and setting up a specified number using a button key of the wireless terminal.

11. The method according to claim 10, wherein said specified number including a private network access code, a function access code, and a characteristic code.

12. The method according to claim 7, wherein, when the setup of the short message service being transmitted through the private network after a predetermined time has lapsed is released, a characteristic code that is made by combining a private network short message service setup function code and a code meaning time is inputted and set up.

13. The method according to claim 12, wherein information on the code indicating time inputted and set up by the user using said button key of said wireless terminal is stored in a timer field of the private network short message service setup table of said private network control station database.

14. The method according to claim 7, wherein, when the number of times which the short message service is transmitted through the private network is intended to be set up and used, a characteristic code that is made by combining the private network short message service setup function code and a code indicating the transmission number of times is inputted and set up.

15. The method according to claim 14, wherein the information on the code indicating the transmission number of times that is inputted and set up by the user using the button keys of the wireless terminal is stored in the field for the transmission number of times in said private network short message service setup table of the private network control station database.

16. A system for providing a short message service in a network interworking between a wireless public network and a wired and wireless private network, comprising:
at least one of a plurality of base transceiver stations for receiving data received from an arbitrary wireless terminal or transmitting data to be transmitted to the arbitrary wireless terminal;
a public network for taking charge of a data control when transmitting and receiving short message service data through a public network, that is transmitted and received through at least one of the base transceiver station;
a private network having a route determination unit for determining through which of the public and private networks to transmit the short message service data using an identifier of a transmission-side terminal included in the short message service data received in said base transceiver station, and transmitting the short message service data to the corresponding network; and
a private network dedicated private short message service center for, when said private network determines that currently received short message service data is a private network short message service data, providing the short message service directly in said private network for itself without passing through said public network.

17. The system according to claim 16, wherein said private network comprises:
a database of a table structure comprising of an identifier field of the transmission-side terminal and a field indicating a short message service route;
a route determination unit for determining a short message service route for the transmission-side terminal identifier with reference to said database and transmitting the transmission-side terminal identifier of the short message service received through said base transceiver station to a corresponding one of said private and public networks; and
a private network control module for, when the data received through a message routing software module is private message service data, transmitting the short message service data to the private short message service center, and when there is an input from the transmission-side terminal with regard to a setup indicating whether to use which of the private and public networks, recording the input detail in the database.

18. The system according to claim 17, wherein the database further includes:
a time field for indicating the amount of time that the user wishes to use the network; and
a field for the transmission number of times for indicating the number of times which the user wishes to use the network.

19. The system according to claim 17, wherein the short message service route field of the database is set up as the public network for an initial setup when the user does not arbitrarily set up the short message service route.

20. The system according to claim 17, wherein said private network control module comprising:
a private network control module for managing a plurality of base transceiver stations and taking charge of a wireless channel setup and frequency hopping process;
a private mobile switching center module for taking charge of a signal switching function; and
a private visitor location register module for storing location information of a terminal.

21. A method for providing a short message service in a network interworking between a wireless public network and a wired and wireless private network, comprising:
transmitting, by a user, a short message service;
determining, at the private network, through which of the public and private networks to transmit the short message service through terminating number information;
transmitting the short message service to a private short message service center when it is determined that the date is the private network passing short message service data according to the terminating number information; and
transmitting the short message service data to the short message service center when it is determined that the data is the public network passing short message service according to the terminating number information.

22. A system for providing a short message service in a network interworking between a wireless public network and a wired/wireless private network, comprising:
a terminal upgraded to transmit a message together with terminating number information when short message service data is transmitted;
at least one base transceiver station for receiving data received from the terminal or transmitting data to be transmitted to an arbitrary wireless terminal;
a private network for determining through which of the public and private networks to transmit the short message service data using terminating number information included in the short message service data message received from the terminal;
a public network for taking charge of a data control when short message service data that is transmitted and received through at least one of said base transceiver station is transmitted and received through said public network; and
a private short message service center for providing the short message service directly in the private network without passing the public network, when it is determined that short message service data currently received from said private network is said private network short message service.

23. The system according to claim 22, wherein the terminal displays the network through which the short message service is transmitted, remaining number of times of transmission and remaining time through a liquid crystal display.

24. A computer-readable medium having computer-executable instructions for performing a method, comprising:
setting up, by a user, through which one of a public and private networks to transmit the short message service;
storing information set up in a private network database; and
when an arbitrary user transmits the short message service, retrieving an identifier of a terminal of the arbitrary user from the private network database, and providing the short message service through a corresponding one of said public and private networks depending on a status set up in said private network database.

25. A computer-readable medium having stored thereon a data structure comprising:
a first field containing data representing transmitting, by a user, a short message service;
a second field containing data representing determining, at a private network, through which of the public and private networks to transmit the short message service through terminating number information;
a third field containing data representing transmitting the short message service to a private short message service center when it is determined that the date is the private network passing short message service data according to the terminating number information; and
a fourth field containing data representing transmitting the short message service data to the short message service center when it is determined that the data is the public network passing short message service according to the terminating number information.
